(19) United States
(12) Patent Application Publication
(10) Pub. No.: US 2009/0199109 A1
(43) Pub. Date: Aug. 6, 2009

(54) CUSTOMIZATION SYSTEM FOR OPERATION SCREEN OF IMAGE FORMING APPARATUS

(75) Inventor: Takayuki DOUI, Kawanishi-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/144,220

(22) Filed: Jun. 23, 2008

(30) Foreign Application Priority Data
Jan. 31, 2008 (JP) 2008-20196
Jan. 31, 2008 (JP) 2008-20279

(51) Int. Cl. G06F 3/048

(52) U.S. Cl. 715/750

(57) ABSTRACT

A customization system acquires information on an operation screen which is customized for a specific user on the basis of customization information for the specific user and judges whether or not the operation screen can be displayed on an operation panel of a specific image forming apparatus out of a plurality of image forming apparatuses on the basis of a result of comparison between the pixel number size of the operation panel and the required pixel number size which is required to display the operation screen. Further, the customization system displays a hierarchical menu screen in which a plurality of buttons included in the operation screen are hierarchized on the operation panel when it is judged that the operation screen can not be displayed on the operation panel.

This application is based on Japanese Patent Application Nos. 2008-20196 and 2008-20279 filed on Jan. 31, 2008, the contents of which are hereby incorporated by reference.

### BACKGROUND OF THE INVENTION

1. Field of the Invention

The present invention relates to a technique to customize a display content on an operation panel of an image forming apparatus.

2. Description of the Background Art

An image forming apparatus is provided with an operation panel for receiving various operation inputs. The operation panel is a liquid crystal display panel in which a piezoelectric sensor or the like is embedded and serves not only as a part of a display part but also as a part of an operation input part. A user presses (virtual) buttons displayed in a screen on the operation panel to input an operation command to an MFP (image forming apparatus).

There is a technique to give flexibility to the display manner of such an operation panel.

Japanese Patent Application Laid Open Gazette No. 2004-180275, for example, discloses that if some of all the buttons to be displayed in an operation panel are not displayed when an operation screen of the operation panel is enlarged, the operation screen is displayed with its layout being changed.

As the technique to give flexibility to the display manner of the operation panel of the image forming apparatus, besides the above technique, there is a possible technique to customize the display content of the operation panel of the image forming apparatus on a user basis.

For example, a server stores customization information on the customization of the display content of an operation panel of one of a plurality of image forming apparatuses for each user. Then, the display contents of operation panels of the others of the image forming apparatuses may be also determined by using the customization information stored in the server. With this technique, a user can perform operation inputs in a plurality of image forming apparatuses by using similarly customized operation screens.

The operation panels of a plurality of image forming apparatuses, however, do not necessarily have the same pixel number size. For this reason, for example, when it is attempted to display an operation screen customized on a relatively large operation panel on a relatively small operation panel, sometimes the operation screen can not be displayed because of difference in pixel number size between these operation panels.

Further, a plurality of image forming apparatuses do not necessarily have the same functions. For this reason, for example, when an operation screen customized on an operation panel of relatively high-function image forming apparatus is displayed on an operation panel of a relatively low-function image forming apparatus, sometimes buttons corresponding to unusable functions are displayed. If these buttons are displayed on the operation panel, the operability is deteriorated.

### SUMMARY OF THE INVENTION

It is an object of the present invention to provide an image forming apparatus capable of displaying a convenient operation screen on a user basis and a technique thereon.

The present invention is directed for a customization system capable of customizing an operation screen displayed on an operation panel of an image forming apparatus on a user basis. According to a first aspect of the present invention, the customization system comprises a storage part for storing customization information for each user, an acquisition part for acquiring information on a customization screen which is an operation screen customized for a specific user on the basis of customization information for the specific user, a judgment part for judging whether or not the customization screen can be displayed on a specific operation panel of a specific image forming apparatus out of a plurality of image forming apparatuses on the basis of a result of comparison between the required pixel number size which is required to display the customization screen and the pixel number size of the specific operation panel, and a display control part for displaying a hierarchical menu screen on the specific operation panel, the hierarchical menu screen being generated by grouping a plurality of buttons included in the customization screen by function when it is judged that the customization screen can not be displayed on the specific operation panel.

The present invention is also directed for an image forming apparatus capable of customizing an operation screen displayed on its operation panel on a user basis. According to a second aspect of the present invention, the image forming apparatus comprises an acquisition part for acquiring information on a customization screen which is an operation screen customized for a specific user on an operation panel of another image forming apparatus other than the image forming apparatus, a judgment part for judging whether or not the customization screen can be displayed on a specific operation panel of the image forming apparatus on the basis of a result of comparison between the required pixel number size which is required to display the customization screen and the pixel number size of the specific operation panel, and a display control part for displaying a hierarchical menu screen on the specific operation panel, the hierarchical menu screen being generated by grouping a plurality of buttons included in the customization screen by function when it is judged that the customization screen can not be displayed on the specific operation panel.

The present invention is still also directed for a server connected to a plurality of image forming apparatuses via a network. According to a third aspect of the present invention, the server comprises a storing part for storing customization information for a specific user on an operation panel of a first image forming apparatus out of a plurality of image forming apparatuses, an acquiring part for acquiring information on a customization screen which is an operation screen customized for the specific user on the basis of the customization information for the specific user in response to a customization information transmission request command from a second image forming apparatus out of the plurality of image forming apparatuses, a judging part for judging whether or not the customization screen can be displayed on a specific operation panel provided in the second image forming apparatus on the basis of a result of comparison between the required pixel number size which is required to display the customization screen and the pixel number size of the specific operation panel, and a generating part for generating a hierarchical menu screen by grouping a plurality of buttons included in the customization screen by function and transmitting information on the hierarchical menu screen to the second image forming apparatus when it is judged that the customization screen can not be displayed on the specific operation panel.

The present invention is further directed for a customization system capable of customizing an operation screen displayed on an operation panel of an image forming apparatus on a user basis. According to a fourth aspect of the present invention, the customization system comprises a storage part for storing customization information for each user, an acquisition part for acquiring information on a customization screen which is customized for a specific user on the basis of customization information for the specific user, a judgment part for judging whether or not there is any unusable function which can not be used in a specific image forming apparatus among functions corresponding to buttons in the customization screen, and a display control part for displaying the customization screen after changing the display mode of a button corresponding to the unusable function on an operation panel of the specific image forming apparatus when it is judged that there is the unusable function.

The present invention is also directed for an image forming apparatus capable of customizing an operation screen displayed on its operation panel on a user basis. According to a fifth aspect of the present invention, the image forming apparatus comprises an acquisition part for acquiring information on a customization screen which is an operation screen customized for a specific user on an operation panel of another image forming apparatus other than the image forming apparatus, a judgment part for judging whether or not there is any unusable function which can not be used in the image forming apparatus among functions corresponding to buttons in the customization screen, and a display control part for displaying the customization screen after changing the display mode of a button corresponding to the unusable function on an operation panel of the image forming apparatus when it is judged that there is the unusable function.

The present invention is still also directed for a server connected to a plurality of image forming apparatuses via a network. According to a sixth aspect of the present invention, the server comprises a storing part for storing customization information for a specific user on an operation panel of a first image forming apparatus out of a plurality of image forming apparatuses, an acquiring part for acquiring information on a customization screen which is an operation screen customized for the specific user on the basis of the customization information for the specific user in response to a customization information transmission request command from a second image forming apparatus out of the plurality of image forming apparatuses, a judging part for judging whether or not there is any unusable function which can not be used in the second image forming apparatus among functions corresponding to buttons in the customization screen, and a transmitting part for transmitting the customization screen after changing the display mode of a button corresponding to the unusable function to the second image forming apparatus when it is judged that there is the unusable function.

The present invention is further directed for a recording medium storing a program to implement the same idea.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a construction of a customization system;

FIG. 2 is a functional block diagram showing a functional constitution of an MFP;

FIG. 3 is a view showing a detailed function list for copy of the MFP;

FIG. 4 is a view showing an exemplary customization screen;

FIG. 5 is a flowchart showing an operation in accordance with a first preferred embodiment;

FIG. 6 is a view showing a customization screen displayed on a relatively large operation panel;

FIG. 7 is a view showing a customization screen (high-level menu screen) after change;

FIGS. 8 to 11 are views each showing a customization screen (low-level menu screen) after change;

FIG. 12 is a flowchart showing an operation in accordance with a second preferred embodiment;

FIG. 13 is a functional block diagram showing a functional constitution of a server;

FIG. 14 is a view showing a customization screen in accordance with a variation;

FIG. 15 is a schematic diagram showing a construction of a customization system;

FIG. 16 is a functional block diagram showing a functional constitution of an MFP;

FIG. 17 is a view showing an exemplary customization screen;

FIG. 18 is a flowchart showing an operation in accordance with a third preferred embodiment;

FIG. 19 is a view showing a customization screen (with grayout display) after change;

FIG. 20 is a view showing a customization screen (with broken-line indication) after change;

FIG. 21 is a view showing a customization screen (partially non-display) after change;

FIG. 22 is a view showing a customization screen (with marks) after change;

FIG. 23 is a flowchart showing an operation in accordance with a fourth preferred embodiment;

FIG. 24 is a functional block diagram showing a functional constitution of a server; and

FIG. 25 is a view showing a customization screen in accordance with a variation.

### DESCRIPTION OF THE PREFERRED EMBODIMENTS

Hereinafter, the preferred embodiments of the present invention will be discussed with reference to the accompanying drawings.

### 1. The First Preferred Embodiment

<1-1. Constitution>

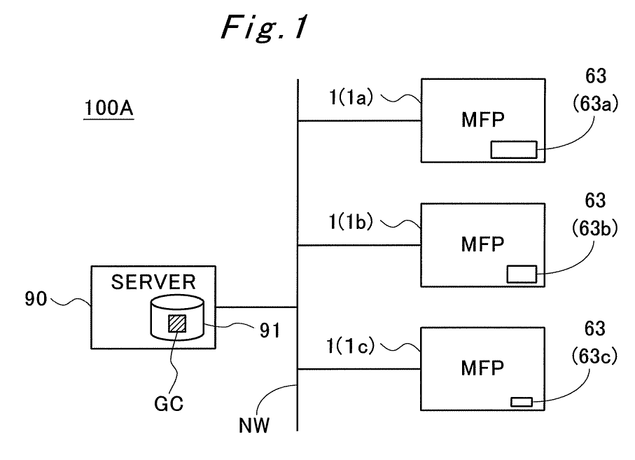

FIG. 1 is a schematic diagram showing a construction of a customization system 100 (specifically, 100A). The customization system 100A comprises a plurality of multi function peripherals (abbreviated as “MFPs”) 1 (specifically, MFPs 1a, 1b, 1c and so on) and a server computer (referred to simply as “a server”) 90. The customization system 100A is capable of customizing an operation screen displayed on an operation panel of each MFP (also referred to as “image forming apparatus”) 1 on a user basis.

Each MFP 1 is connected to the server 90 via a network NW and capable of transmitting and receiving data to/from the server 90. On the other hand, the server 90 stores customization information for each user in its storage part 91. Each MFP 1 can use the customization information stored in the server 90 (specifically in the storage part 91 of the server 90) to customize an operation screen displayed on its operation panel on a user basis. The network NW includes a LAN (Local Area Network) and various networks such as the internet.

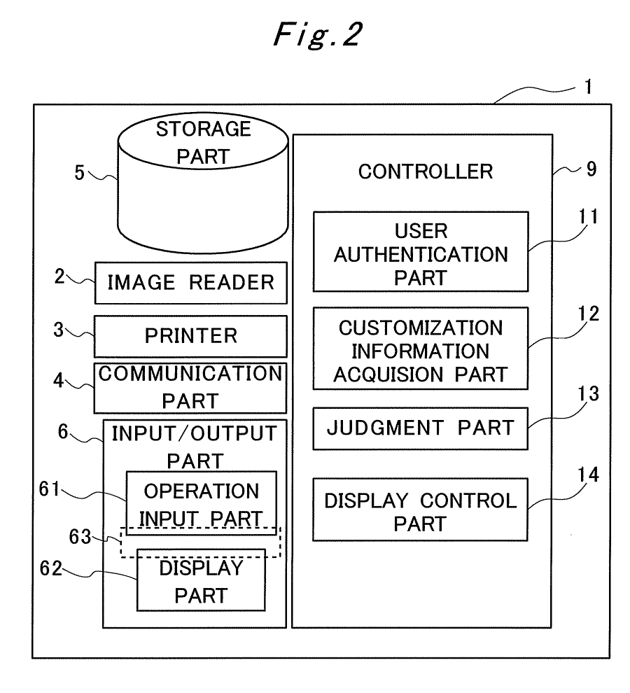

FIG. 2 is a functional block diagram showing a functional constitution of each MFP 1. The MFP 1 is an apparatus (also referred to as “multiple function processing machine”) having a scanner function, a printer function, a copy function, a facsimile function and the like. More specifically, as shown in FIG. 2, the MFP 1 comprises an image reader 2, a printer 3, a communication part 4, a storage part 5, an input/output part 6 and a controller 9, and multiply uses these constituent parts to implement the above functions.

The image reader 2 is a processing part which optically reads an original (manuscript) placed on a predetermined position of the MFP 1 and generates image data (a manuscript image) of the original.

The printer 3 is an output part which prints out the image to various media such as paper on the basis of the image data on an object image.

The communication part 4 is a processing part capable of performing facsimile communication via public networks or the like. Further, the communication part 4 is capable of performing network communication via a communication network NW. The network communication uses various protocols such as TCP/IP (Transmission Control Protocol/Internet Protocol), FTP (File Transfer Protocol) and the like, and by using the network communication, the MFP 1 can transmit and receive various data to/from desired partners. Further, the MFP 1 can transmit and receive electronic mails by using the network communication.

The storage part 5 is a storage device such as a hard disk drive (HDD) or/and the like. In the storage part 5, the manuscript image (image data) generated by the image reader 2 or the like is stored.

The input/output part 6 comprises an operation input part 61 for receiving an input which is given to the MFP 1 and a display part 62 for performing display output of various information. Further, the MFP 1 is provided with an operation panel 63 (see FIGS. 1 and 2). The operation panel 63 is a liquid crystal display panel in which a piezoelectric sensor or the like is embedded and serves not only as a part of the display part 62 but also as a part of the operation input part 61. A user presses (virtual) buttons displayed on the operation panel 63 to input operation commands to the MFP 1.

The controller 9 is a control device for generally controlling the MFP 1 and comprises a CPU and various semiconductor memories (RAM, ROM and the like). These processing parts operate inder the control of the controller 9 to implement the above functions of the MFP 1. For example, under the control of the controller 9, the image reader 2 optically reads a desired image to acquire an image (scanned image) which is obtained by scanning the original, thus implementing the scanner function. Further, the printer 3 prints out the scanned image, thus implementing the copy function. The controller 9 also controls various processings discussed below.

The controller 9 causes the CPU to execute a predetermined software program (hereinafter, referred to simply as “program”) stored in the ROM (e.g., EEPROM or the like), to thereby implement various processing parts. Further, the program may be provided via a network or from a predetermined recording medium (e.g., a USB memory (portable memory), a CD-ROM or the like).

Specifically, the controller 9 implements various processing parts including a user authentication part 11, a customization information acquisition part 12, a judgment part 13 and a display control part 14.

The user authentication part 11 is a processing part for controlling an authentication operation on each user (personal user).

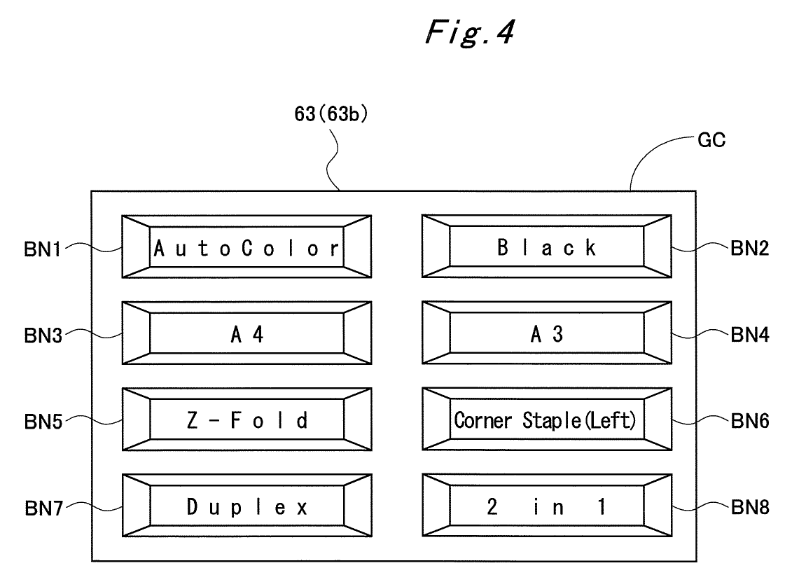

The customization information acquisition part 12 is a processing part which performs communication with the server 90 to acquire a customization screen GC stored in the storage part 91. The customization information acquisition part 12 can acquire information of a customization screen GC which is customized for a specific user on an operation panel 63 of an MFP 1, whether the MFP 1 is one including the part 12 or not. For example, the customization information acquisition part 12 of the MFP 1c (see FIG. 1) can acquire information of a customization screen (operation screen) GC (see FIG. 4) which is customized for a user UA on the operation panel 63b of the MFP 1b (to which the part 12 does not belong) other than the MFP 1c (to which it belongs). Further, the customization information acquisition part 12 of the MFP 1b can also acquire information of the customization screen which is customized for the user UA on the operation panel 63b of the MFP 1b (to which the part 12 belongs).

The judgment part 13 is a processing part which judges whether the customization screen GC can be displayed on the operation panel 63 (e.g., 63c) of the MFP 1 (e.g., 1c) or not on the basis of a result of comparison between the required pixel number size which is required to display the customization screen GC and the pixel number size of the operation panel 63 (e.g., 63c) of the MFP 1 (e.g., 1c).

The display control part 14 controls a display operation on the operation panel 63. If it is judged that the customization screen GC can not be displayed on the operation panel 63, especially, the display control part 14 displays a new operation screen which is generated by grouping (or integrating) a plurality of buttons (e.g., buttons BN1 to BN8) included in the customization screen GC by function, on the operation panel 63.

<1-2. List of Functions>

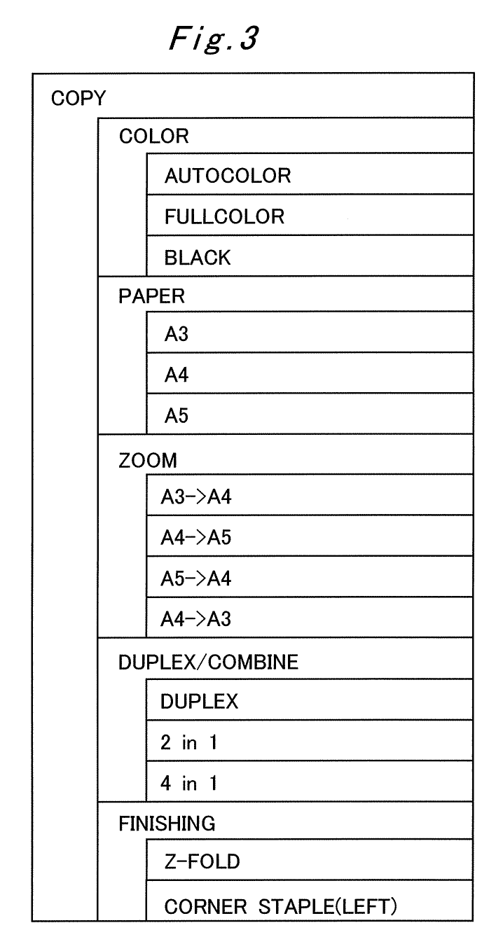

FIG. 3 is a view showing a detailed function list for copy of the MFP 1.

The MFP 1 has hierarchical functions on a copy operation as shown in FIG. 3.

Specifically, first, a large item set “Copy” includes five middle item sets “Color”, “Paper”, “Zoom”, “Duplex/Combine” and “finishing”.

Further, the middle item set “Color” includes three small item sets “AutoColor”, “FullColor” and “Black”. The middle item set “Paper” includes three small item sets “A3”, “A4” and “A5”. The middle item set “Zoom” includes four small item sets “A3->A4”, “A4->A5”, “A5->A4” and “A4->A3”. The middle item set “Duplex/Combine” includes three small item sets “Duplex”, “2 in 1” and “4 in 1”. The middle item set “Finishing” includes two small item sets “Z-Fold” and “Corner Staple”.

The MFP 1 further comprises the scanner function, the printer function and the facsimile function besides the copy function as discussed above. In the first preferred embodiment, discussion will be made, centering on an operation of the copy function.

The operation panel 63 of the MFP 1 receives various input operations to implement various detailed functions as shown in FIG. 3.

In this MFP 1, two kinds of input methods can be adopted. The first method is to display a default operation screen (menu screen) for selection of a desired function. The second method is to display buttons corresponding to the function selected by a user among a number of buttons. In other words, the second method is a method to generate a customization screen for displaying the buttons for selection of functions, which are customized on a user basis, and implement a function selection operation using the customization screen. By the second method, each user can easily make access to frequently-used buttons. Hereafter, detailed discussion will be made on a case using the second method.

<1-3. Customization Screen>

FIG. 4 is a view showing an exemplary customization screen GC. FIG. 4 shows a customization screen GC displaying eight buttons which are selected as ones frequently used by the user UA. In more detail, the eight buttons corresponding to eight detailed functions selected by the user UA are arranged in two columns and four rows.

In the customization screen GC for the user UA, the top row has two buttons BN1 and NM2 corresponding to the two small item sets which belong to the middle item set “Color”, specifically, the button BN1 corresponding to the small item set “AutoColor” and the button BN2 corresponding to the small item set “Black”. The second row has the button BN3 corresponding to the small item set “A4” and the button BN4 corresponding to the small item set “A3”, which belong to the middle item set “Paper”. The third row has the button BN5 corresponding to the small item set “Z-Fold” and the button BN6 corresponding to the small item set “Corner Staple”, which belong to the middle item set “Finishing”. The bottom row has the button BN7 corresponding to the small item set “Duplex” and the button BN8 corresponding to the small item set “2 in 1”, which belong to the middle item set “Duplex/Combine”.

Such a customization screen GC is generated by each user operating a computer connected to the MFP 1 and the server 90 or only the server 90. The information on the generated customization screen GC is stored in the storage part 91 of the server 90 as customization information. In other words, the customization information includes the information on the customization screen GC. In more detail, the customization information includes the size (pixel number size) of the customization screen GC, the number of buttons included in the customization screen GC and the names, the corresponding functions, the sizes, the positions and the like of the buttons included in the customization screen GC. The customization information is acquired from the server 90 via a network NW, and the customization screen GC indicated by the customization information is used in each MFP. Hereinafter, discussion will be made, assuming that the customization screen GC is generated on the MFP 1b.

<1-4. Operation>

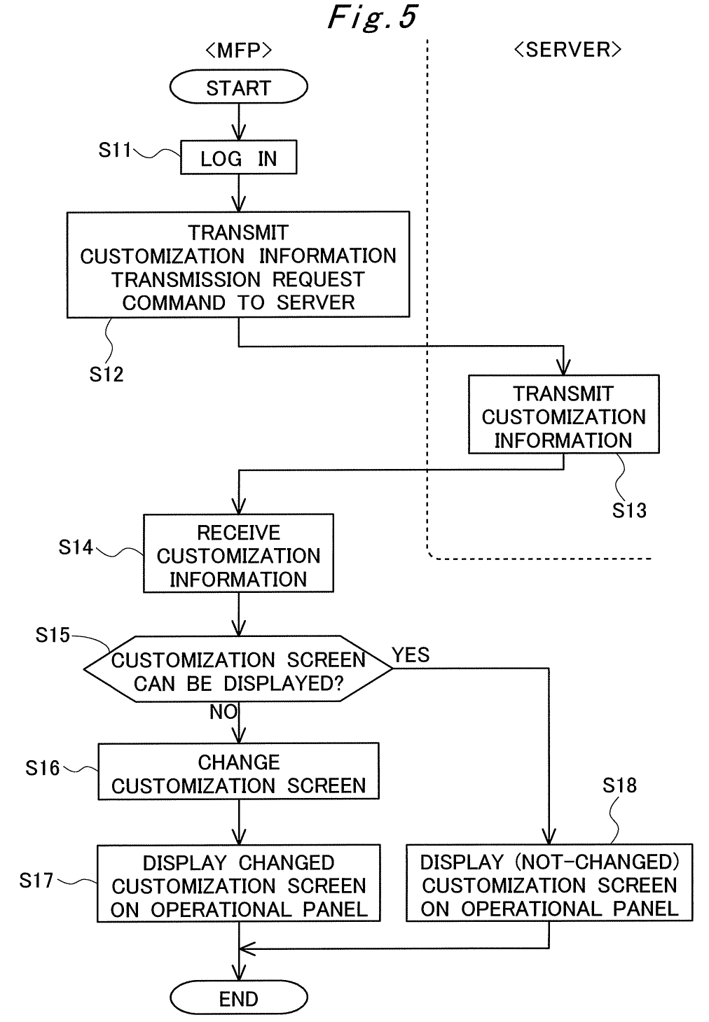

Next, an operation of the first preferred embodiment will be discussed, referring to the flowchart of FIG. 5. Before execution of the operation of the flowchart shown in FIG. 5, an operation of generating such a customization screen GC as shown in FIG. 4 is performed in advance.

First, in Step S11, the user UA logs in the MFP 1 (e.g., 1c) to be used. Specifically, the user UA uses the operation input part 61 to input a user ID and a password, thus performing a login operation.

In the next Step S12, the MFP 1 transmits a customization information transmission request command on the user UA to the server 90.

Receiving the customization information transmission request command, the server 90 retrieves the customization information (for the user UA) corresponding to the request command out of a plurality of pieces of customization information for a plurality of users which are stored in the storage part 91 of the server 90. Then, the server 90 transmits the retrieved customization information to the MFP 1 (Step S13).

In Step S14, receiving the customization information transmitted from the server 90, the MFP 1 extracts information on the customization screen GC out of the customization information.

In the next Step S15, the MFP 1 judges whether the customization screen GC can be displayed on its operation panel 63 or not on the basis of the information on the customization screen (operation screen) GC which is included in the customization information. The detailed operation for judgment will be discussed later.

If it is judged that the customization screen GC can be displayed on the operation panel 63 of the MFP 1, the process goes to Step S18, where the customization screen GC is displayed on the operation panel 63 of the MFP 1.

On the other hand, if it is judged that the customization screen GC can not be displayed on the operation panel 63 of the MFP 1, the process goes to Step S16. In Step S16, the MFP 1 changes the customization screen GC. Specifically, the MFP 1 generates a new operation screen (hierarchical menu screen GE) by grouping a plurality of buttons included in the customization screen GC by function. The operation of changing the customization screen GC will be discussed later.

Then, in Step S17, the MFP 1 displays the changed customization screen GC (hierarchical menu screen GE) on its operation panel 63.

After Step S17 or S18, the user performs operation inputs by using the operation screen displayed on the operation panel 63, and a processing in accordance with the operation inputs is performed.

The MFPs 1 each perform the above-discussed operations shown in FIG. 5.

Next, detailed discussion will be made on change of the customization screen GC. As discussed earlier, herein, discussion will be made, assuming that the customization screen GC is generated for the operation panel 63b of the MFP 1b. Further, it is assumed that among the three MFPs 1a, 1b and 1c, the operation panel 63a of the MFP 1a is the largest one, the operation panel 63b of the MFP 1b is the second largest one and the operation panel 63c of the MFP 1c is the smallest one (see FIG. 1). In other words, it is assumed that the pixel number size Sa of the operation panel 6a of the MFP 1a is largest, the pixel number size Sb of the operation panel 63b of the MFP 1b is second largest and the pixel number size Sc of the operation panel 63c of the MFP 1c is smallest (Sa>Sb>Sc). Specifically, the pixel number size Sa of the operation panel 63a is 800×480 pixels, the pixel number size Sb of the operation panel 63b is 640×480 pixels and the pixel number size Sc of the operation panel 63c is 640×240 pixels. Further, the pixel number size Sz required to display the customization screen GC for the operation panel 63b is equal to or less than the pixel number size Sb of the operation panel 63b, herein assuming 620×460 pixels.

In the MFP 1a having a relatively large operation panel 63a, for example, if the customization screen GC for the MFP 1b is used, the following operation is performed in the flowchart of FIG. 5.

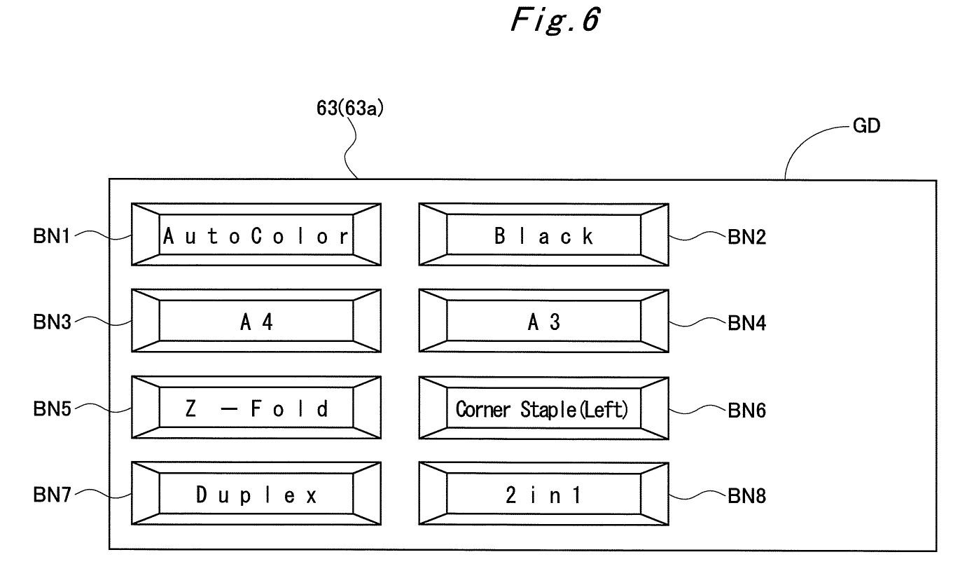

As discussed above, the pixel number size Sa of the operation panel 63a of the MFP 1a is larger than the pixel number size Sb of the operation panel 63b of the MFP 1b. Therefore, the pixel number size Sa of the operation panel 63a of the MFP 1a is larger than the pixel number size Sz required to display the customization screen GC. For this reason, in Step S15, it is judged that the customization screen GC for the operation panel 63b can be displayed, not being changed, on the operation panel 63a of the MFP 1a. Then, in Step S18, the customization screen GC is displayed on the operation panel 63a in the display manner GD of FIG. 6. In this case, the relatively small customization screen GC is displayed on the relatively large operation panel 63a so that both left upper points can coincide with each other. The display manner, however, is not limited to this, and there may be a case, for example, where the customization screen GC is so displayed as to be centered in the longitudinal direction and/or the transverse direction on the operation panel 63a.

In another case, if the customization screen GC for the MFP 1b is used in the MFP 1b, similarly, the customization screen GC can be displayed, not being changed, on the operation panel 63b (see FIG. 4).

On the other hand, if the customization screen GC for the MFP 1b is used in the MFP 1c having the relatively small operation panel 63 (63c), the following operation is performed in the flowchart of FIG. 5.

The pixel number size Sc (640×240 pixels) of the operation panel 63c of the MFP 1c is smaller than the pixel number size Sb of the operation panel 63b of the MFP 1b and smaller than the pixel number size Sz (620×460 pixels) required to display the customization screen GC (especially in the longitudinal direction). For this reason, in Step S15, it is judged that the customization screen GC for the operation panel 63b can not be displayed, as it is, on the operation panel 63c of the MFP 1c. Then, in Step S16, a hierarchical menu screen GE is generated as the changed customization screen GC, and in Step S17, the hierarchical menu screen GE is displayed on the operation panel 63c.

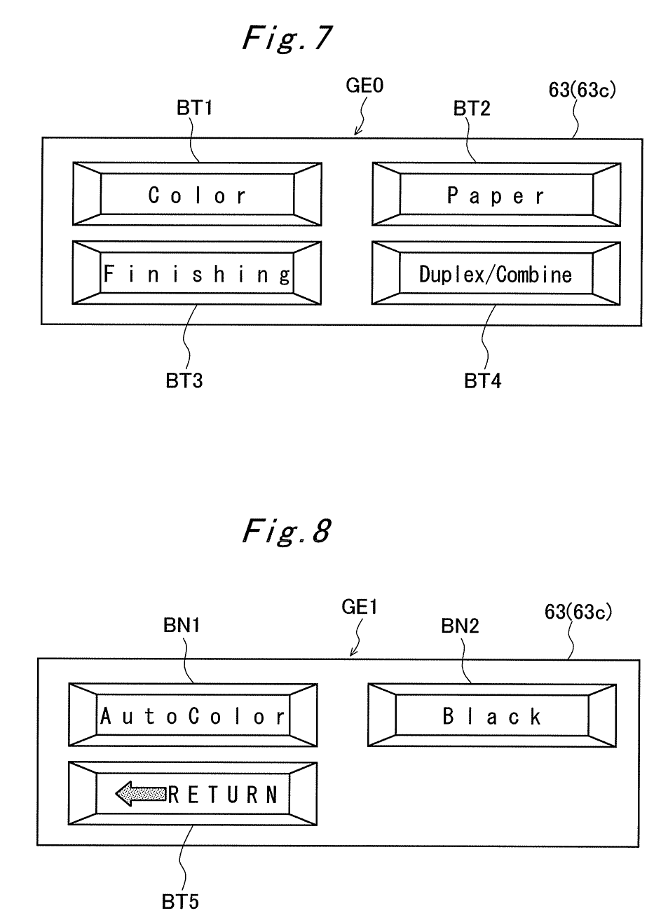

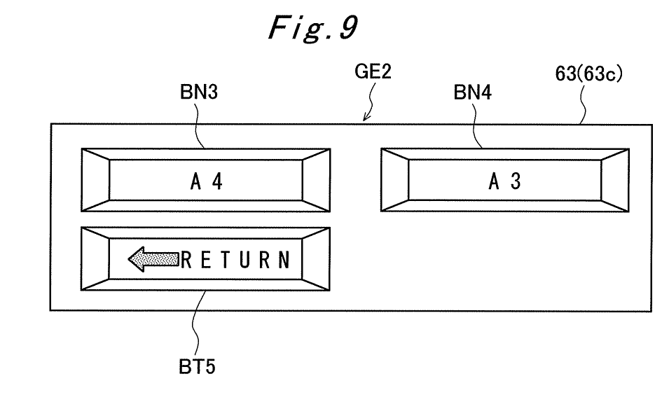

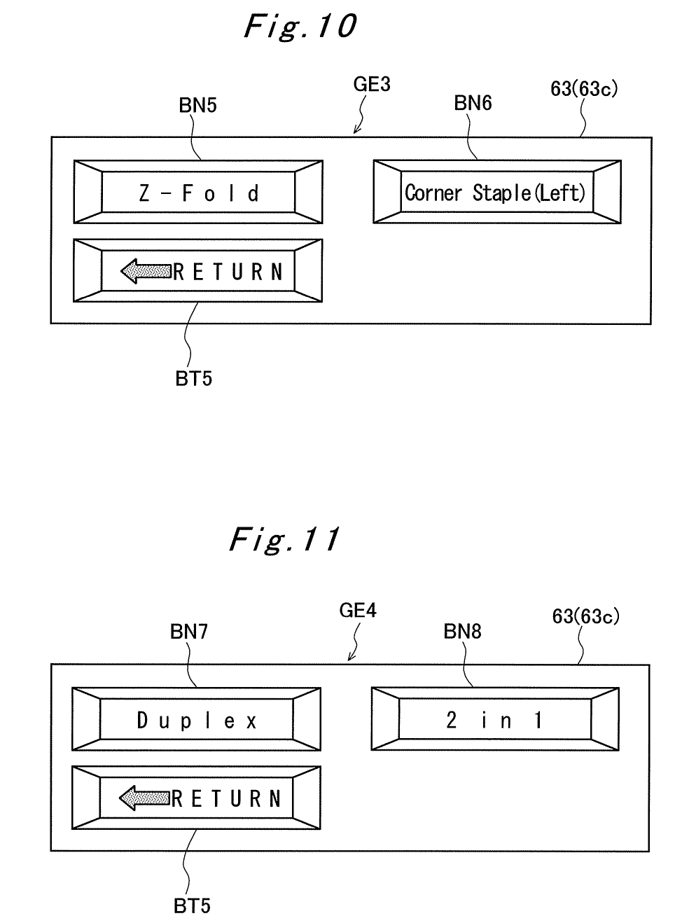

The hierarchical menu screen GE includes a high-level menu screen GE0 (FIG. 7) which is a menu screen of relatively higher level and four low-level menu screens GE1 (FIG. 8), GE2 (FIG. 9), GE3 (FIG. 10) and GE4 (FIG. 11) which are menu screens of relatively lower level.

These menu screens GE0 to GE4 are automatically generated on the basis of information on the customization screen GC (FIG. 4) and information on the hierarchical structure of the function list (FIG. 3).

First, in order to generate the above menu screens GE0 to GE4, the maximum number of buttons to be drawn in the operation panel 63c, i.e., the maximum arrangement button number MB of each of the menu screens GE0 to GE4 is obtained.

It is assumed, for example, that the size BS of an area required to arrange one button (a total area of an area for the button and a margin area around the button) is fixed to a predetermined value (herein, 310×115 pixels). The size BS is also assumed to be included in the information on the customization screen GC.

In this case, in the operation panel 63c (size: 640×240 pixels), two buttons can be arranged in the transverse direction at the maximum and two buttons can be arranged in the longitudinal direction at the maximum. Therefore, in each of the menu screens GE0 to GE4, four (2×2) buttons can be arranged at the maximum. In other words, the maximum button number MB is “4”.

Next, the MFP 1c integrates the eight buttons BN1 to BN8 by assigned functions on the basis of the information on the eight buttons BN1 to BN8 provided in the customization screen GC (FIG. 4) and the information on the hierarchical structure of the function list (FIG. 3). In other words, the eight buttons BN1 to BN8 are grouped and hierarchized in accordance with their assigned functions.

Specifically, first, the four middle item sets corresponding to the eight small item sets assigned to the eight buttons BN1 to BN8 in the customization screen GC of FIG. 4 are extracted, and a menu screen (high-level menu screen) GE0 on the middle item sets is generated. In more detail, in the menu screen GE0 (FIG. 7), four buttons BT1 to BT4 corresponding to the four middle item sets “Color”, “Paper”, “Finishing” and “Duplex/Combine” are provided. Specifically, the high-level menu screen GE0 has the buttons BT1 to BT4 of relatively higher items corresponding to the groups (middle item sets) which are allocation targets of a plurality of buttons BN1 to BN8. In other words, the high-level menu screen GE0 has the buttons BT1 to BT4 of relatively higher items with respective item names of the groups which are allocation targets of a plurality of buttons BN1 to BN8. Further, it is found that the number of middle item sets (=4) is equal to or less than the maximum button number MB (=4). With these operations, the MFP 1c generates the menu screen GE0.

Next, with respect to the four middle item sets, the MFP 1c generates respective menu screens (low-level menu screens) GE1 to GE4 corresponding to the small item sets included in the four middle item sets. To each of the low-level menu screens GE1 to GE4, at least one of a plurality of buttons BN1 to BN8 (the buttons of relatively lower items by comparison with the buttons BT1 to BT4 of relatively higher items) is allocated. Also in generation of these menu screens GE1 to GE4, it is found that the number of buttons in each of the menu screens GE1 to GE4 is equal to or less than the maximum button number MB (=4). In the first preferred embodiment, however, since a button BT5 (see FIG. 8) for returning to the high-level menu screen is provided, the number of small item sets in each of the menu screens GE1 to GE4 is limited to the number which is the maximum button number MB minus one (i.e., equal to or less than 3).

The menu screen GE1 (FIG. 8) is a sub-menu screen displaying customized small item sets on the middle item set “Color”. In the menu screen GE1 provided are two buttons BN1 and BN2. The two buttons BN1 and BN2 are buttons corresponding to the small item sets on the middle item set “Color”, which are present in the customization screen GC. In the menu screen GE1, further provided is the button BT5 for returning to the high-level menu screen GE0.

The menu screen GE2 (FIG. 9) is a sub-menu screen displaying customized small item sets on the middle item set “Paper”. In the menu screen GE2 provided are two buttons BN3 and BN4 on the middle item set “Paper” in the customization screen GC. In the menu screen GE2, further provided is the button BT5 for returning to the high-level menu screen GE0.

The menu screen GE3 (FIG. 10) is a sub-menu screen displaying customized small item sets on the middle item set “Finishing”. In the menu screen GE3 provided are two buttons BN5 and BN6 on the middle item set “Finishing” in the customization screen GC. In the menu screen GE3, further provided is the button BT5 for returning to the high-level menu screen GE0.

The menu screen GE4 (FIG. 11) is a sub-menu screen displaying customized small item sets on the middle item set “Duplex/Combine”. In the menu screen GE4 provided are two buttons BN7 and BN8 on the middle item set “Duplex/Combine” in the customization screen GC. In the menu screen GE4, further provided is the button BT5 for returning to the high-level menu screen GE0.

These menu screens GE0 to GE4 are selectively displayed on the operation panel 63c as appropriate.

Specifically, the menu screen GE0 (FIG. 7) out of the menu screens GE0 to GE4 is first displayed on the operation panel 63c. In other words, the high-level menu screen GE0 is displayed prior to the low-level menu screens GE1 to GE4.

Then, when any one of the four buttons BT1 to BT4 in the menu screen GE0 is pressed, the menu screen (any one of the menu screens GE1 to GE4) corresponding to the pressed button is displayed on the operation panel 63c, replacing the menu screen GE0. When the button BT1 is pressed, for example, the menu screen GE1 is displayed on the operation panel 63c. Further, when the button BT2 is pressed, the menu screen GE2 is displayed on the operation panel 63c. Similarly, when the button BT3 is pressed, the menu screen GE3 is displayed on the operation panel 63c, and when the button BT4 is pressed, the menu screen GE4 is displayed on the operation panel 63c.

The above operations are performed. With these operations, it is possible to display convenient operation screens on a user basis in consideration of the difference in size among the operation panels. Since the buttons are integrated by function and then displayed, especially, easy-to-understand operation screens can be displayed.

In the above-discussed case, since the number of small item sets (the small item set number MA) which belong to each of the four middle item sets selected by customization is smaller than the maximum button number MB, the respective menu screens GE1 to GE4 corresponding to the four middle item sets are each generated as a single screen.

Not limited to this, however, if the number MA of small item sets belonging to each middle item set exceeds the maximum button number MB (or if the small item set number MA is equal to or larger than the maximum button number MB), the menu screen corresponding to the middle item set may be divided into a plurality of screens.

Alternatively, if the number MA of small item sets belonging to each middle item set exceeds the maximum button number MB (or the small item set number MA is equal to or larger than the maximum button number MB) and the middle item set further has a detailed function group, a middle sub-menu screen in accordance with the detailed function group may be provided. For example, if the “Duplex/Combine” printing function is further grouped into “Duplex” and “Combine”, a “Duplex” button and a “Combine” button are provided in the menu screen GE4, and in response to a press of each of these buttons, one of more detailed menu screens (each having buttons corresponding to its small item sets) may be displayed. Even if there are five small item sets on the middle item set “Duplex/Combine” in the customization screen GC, in more detail, if there are two small item sets on “Duplex” and there are three small item sets on “Combine” in the customization screen GC, with this operation, it is possible to display easy-to-understand hierarchical menu screen on the operation panel 63.

### 2. The Second Preferred Embodiment

Next, the second preferred embodiment will be discussed. Though discussion has been made in the above first preferred embodiment on the case where the MFP 1 performs the operation of judging the possibility of displaying the customization screen GC and the operation of generating a new customization screen, the present invention is not limited to this case. In the second preferred embodiment, discussion will be made on a case where the server 90 performs the operation of judging the possibility of displaying the customization screen GC and the operation of generating a new customization screen. Hereinafter, discussion will be centered on the characterized feature different from that of the first preferred embodiment.

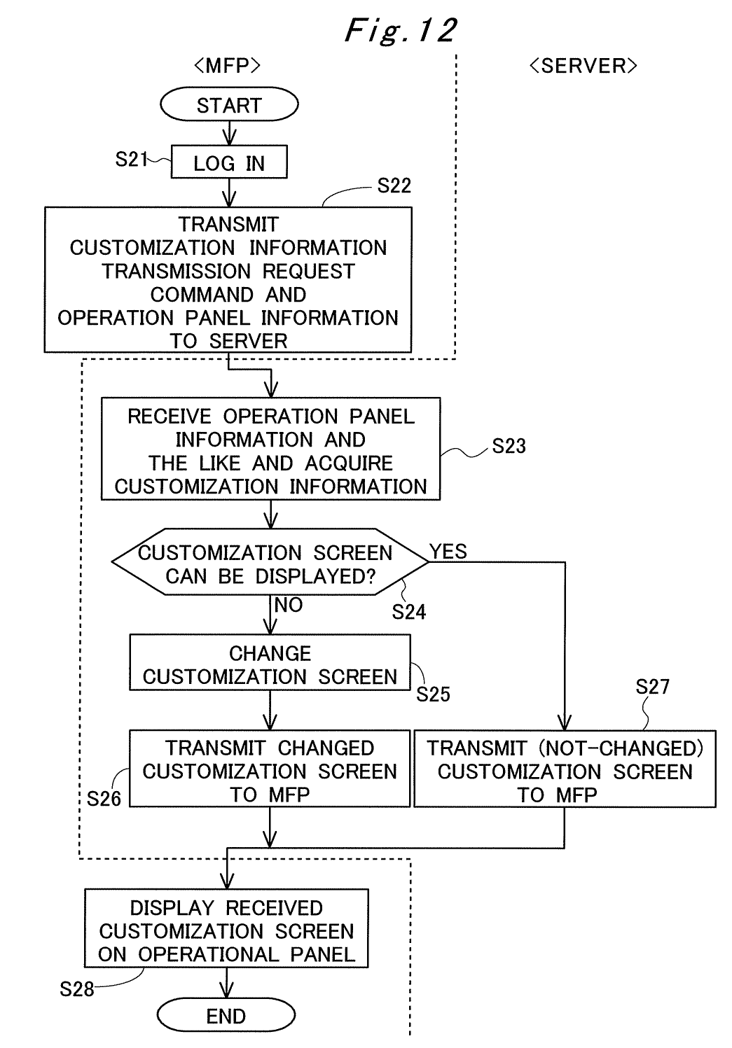

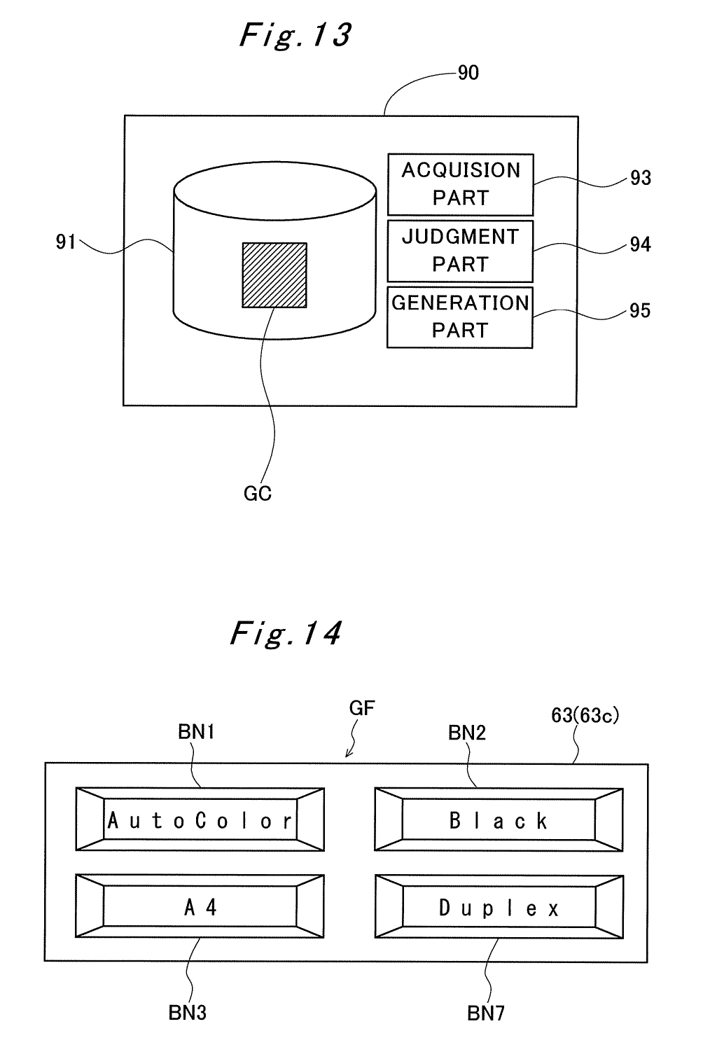

FIG. 12 is a flowchart showing an operation in accordance with the second preferred embodiment. FIG. 13 is a view showing various functional parts implemented by execution of a predetermined program in the CPU and the like of the server 90. In the second preferred embodiment, instead of the operation shown in FIG. 5, the operation shown in FIG. 12 is performed.

As shown in FIG. 12, first, in Step S21, the user UA logs in the MFP 1. Specifically, the user UA uses the operation input part 61 of the MFP 1 (e.g., 1c) to input a user ID and a password, thus performing a login operation.

In the next Step S22, in response to the login operation by the use UA, the MFP 1 transmits the customization information transmission request command on the user UA to the server 90. The MFP 1 also transmits information on the operation panel 63 of the MFP 1 (specifically, pixel number size information of the operation panel 63 and the like) to the server 90.

In Step S23, the server 90 receives and acquires the information on the operation panel 63 of the MFP 1. The server 90 also receives the customization information transmission request command from the MFP 1 (e.g., 1c) in Step S23. In response to the request command, the server 90 retrieves the customization information corresponding to the request command out of a plurality of pieces of customization information for a plurality of users which are stored in the storage part 91 of the server 90. Specifically, the server 90 acquires the customization information for the user UA and acquires information of an operation screen (customization screen) GC which is customized for the user UA. This acquisition operation is performed by the acquisition part 93 implemented by execution of software in the CPU and the like of the server 90.

In the Step S24, the server 90 judges whether the customization screen GC can be displayed on the operation panel 63 (e.g., 63c) of the MFP 1 (e.g., 1c) or not on the basis of the information on the customization screen (operation screen) GC which is included in the customization information and the pixel number size information of the operation panel 63. In more detail, the server 90 makes the judgment on the basis of a result of comparison between the required pixel number size which is required to display the customization screen GC and the pixel number size of the operation panel 63 (e.g., 63c) of the MFP 1 (e.g., 1c). This judgment operation is performed by the judgment part 94 implemented by execution of software in the CPU and the like of the server 90.

If it is judged that the customization screen GC can be displayed on the operation panel 63 of the MFP 1, the process goes to Step S27, where the information on the customization screen GC is transmitted from the server 90 to the MFP 1. After that, in Step S28, the MFP 1 displays the customization screen GC (not changed).

On the other hand, if it is judged that the customization screen GC can not be displayed on the operation panel 63 of the MFP 1, the process goes to Step S25. In Step S25, the server 90 changes the customization screen GC and generates the hierarchical menu screen GE by grouping a plurality of buttons included in the customization screen GC by function. Then, in Step S26, the server 90 transmits information on the changed customization screen GC (i.e., the hierarchical menu screen GE) to the MFP 1 (e.g., 1c). This operation of generating screens and the like are performed by the generation part 95 implemented by execution of software in the CPU and the like of the server 90.

After that, in Step S28, the MFP 1 displays the received customization screen GC on its operation panel 63. In other words, the MFP 1 displays the changed customization screen (hierarchical menu screen GE).

The MFPs 1 each perform the above operations.

With these operations, the same effect as produced in the first preferred embodiment can be produced.

### 3. The Third Preferred Embodiment

<3-1. Constitution>

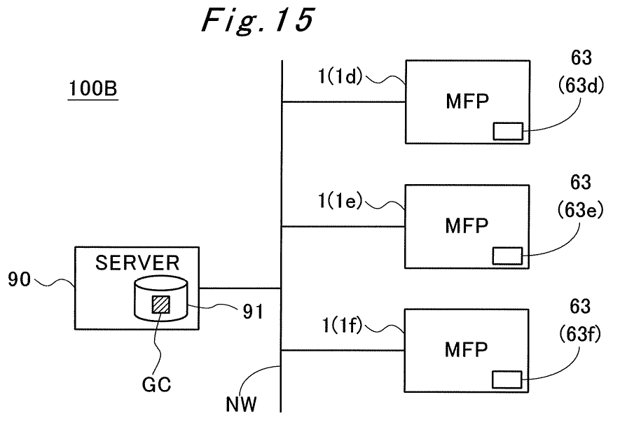

FIG. 15 is a schematic diagram showing a construction of a customization system 100 (specifically, 100B) in accordance with the third preferred embodiment. The customization system 100B comprises a plurality of multi function peripherals (abbreviated as “MFPs”) 1 (specifically, MFPs 1d, 1e, 1f and so on) and a server computer (referred to simply as “a server”) 90. The customization system 100B is capable of customizing an operation screen displayed on an operation panel of each MFP (also referred to as “image forming apparatus”) 1 on a user basis.

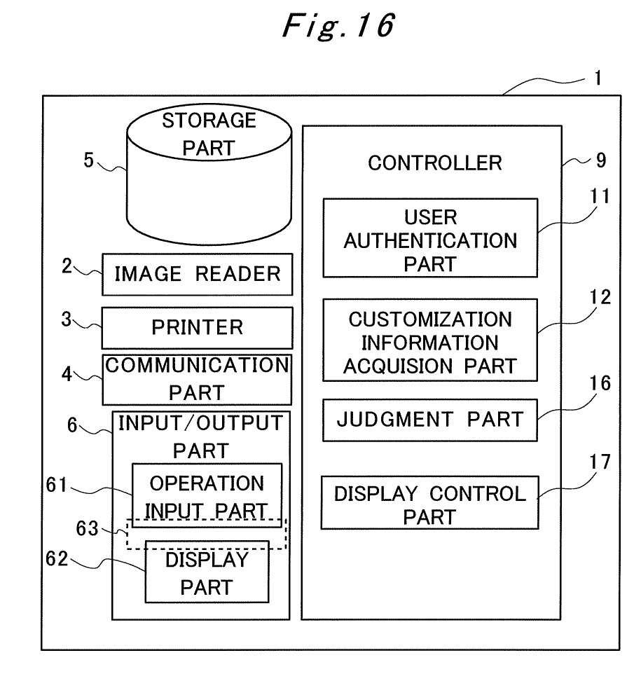

The customization system 100B of the third preferred embodiment has the same constitution as that of the customization system 100A of the first preferred embodiment. Further, the MFP 1 (MFPs 1d, 1e, 1f and so on) of the third preferred embodiment also has the same constitution as that of the MFP 1 (MFPs 1a, 1b, 1c and so on) of the first preferred embodiment. Operations performed by the controller 9 and the like, however, are different from those in the first preferred embodiment. Hereinafter, discussion will be centered on the difference between the first and third preferred embodiments, referring to the functional block diagram of FIG. 16.

The controller 9 of the third preferred embodiment executes a predetermined program in its CPU to implement various processing parts including the user authentication part 11, the customization information acquisition part 12, the judgment part 16 and the display control part 17.

The user authentication part 11 is a processing part for controlling an authentication operation on each user (personal user).

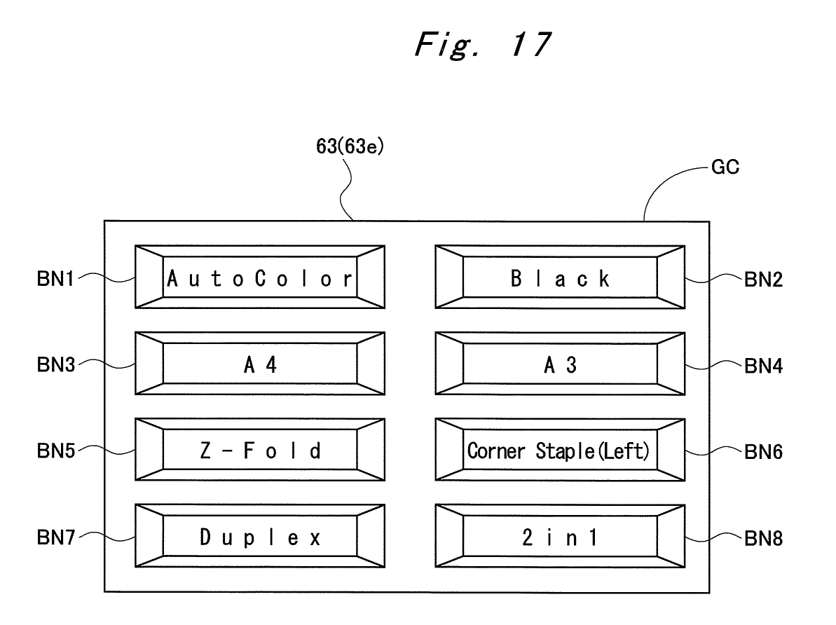

The customization information acquisition part 12 is a processing part which performs communication with the server 90 to acquire a customization screen GC stored in the storage part 91. The customization information acquisition part 12 can acquire information of a customization screen GC which is customized for a specific user on an operation panel 63 of an MFP 1, whether the MFP 1 is one including the part 12 or not. For example, the customization information acquisition part 12 of the MFP 1f (see FIG. 15) can acquire information of a customization screen (operation screen) GC (see FIG. 17) which is customized for the user UA on the operation panel 63e of the MFP 1e (to which the part 12 does not belong) other than the MFP 1f (to which it belongs). Further, the customization information acquisition part 12 of the MFP 1e can also acquire information of the customization screen which is customized for the user UA on the operation panel 63e of the MFP 1e (to which the part 12 belongs).

The judgment part 16 is a processing part which judges whether or not there is any function which can not be used in the MFP 1 (to which the part 16 belongs)(such a function is also referred to as “unusable function”) among the functions corresponding to the buttons in the customization screen GC.

The display control part 17 controls a display operation on the operation panel 63. If it is judged that there is an “unusable function” among the functions corresponding to the buttons in the customization screen GC, especially, the display control part 17 generates a customization screen GC in which the mode (or form) for display (“display mode” or “display form”) of the button corresponding to the “unusable function” is changed and displays the changed customization screen GC on the operation panel 63 of the MFP 1. The display control part 17 also performs an operation of changing the mode of the button corresponding to the “unusable function” into an “unselectable mode” (where the button can not be selected).

<3-2. List of Functions>

Also the MFP 1 of the third preferred embodiment has the above-discussed hierarchical functions on a copy operation (see FIG. 3).

The MFP 1 further comprises the scanner function, the printer function and the facsimile function besides the copy function as discussed above. Also in the third preferred embodiment, discussion will be made, centering on an operation of the copy function.

The operation panel 63 of the MFP 1 receives various input operations to implement various detailed functions as shown in FIG. 3.

Also in the MFP 1 of the third preferred embodiment, two kinds of input methods can be adopted. The first method is to display a default operation screen (menu screen) for selection of a desired function. The second method is to display buttons corresponding to the function selected by a user among a number of buttons. In other words, the second method is a method to generate a customization screen for displaying the buttons for selection of functions, which are customized on a user basis, and implement a function selection operation using the customization screen. By the second method, each user can easily make access to frequently-used buttons. Hereafter, detailed discussion will be made on a case using the second method.

<3-3. Customization Screen>

FIG. 17 is a view showing an exemplary customization screen GC. FIG. 17 shows a customization screen GC displaying eight buttons which are selected as ones frequently used by the user UA. In more detail, the eight buttons corresponding to eight detailed functions selected by the user UA are arranged in two columns and four rows.

This customization screen GC (see FIG. 17) is the same as the customization screen GC of the first preferred embodiment (see FIG. 4), and detailed discussion thereof will be omitted. Hereinafter, discussion will be made, assuming that the customization screen GC (FIG. 17) is generated on the MFP 1e.

<3-4. Operation>

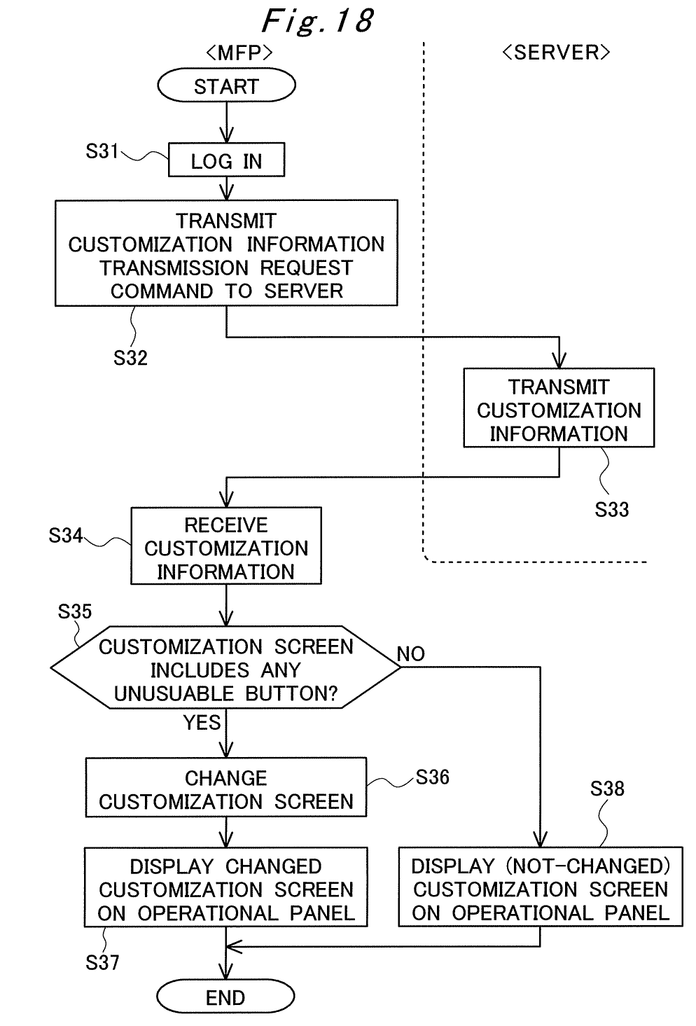

Next, an operation of the third preferred embodiment will be discussed, referring to the flowchart of FIG. 18. Before execution of the operation of the flowchart shown in FIG. 18, an operation of generating such a customization screen GC as shown in FIG. 17 is performed in advance.

First, in Step S31, the user UA logs in the MFP 1 (e.g., 1f) to be used. Specifically, the user UA uses the operation input part 61 to input a user ID and a password, thus performing a login operation.

In the next Step S32, the MFP 1 transmits a customization information transmission request command on the user UA to the server 90.

Receiving the customization information transmission request command, the server 90 retrieves the customization information (for the user UA) corresponding to the request command out of a plurality of pieces of customization information for a plurality of users which are stored in the storage part 91 of the server 90. Then, the server 90 transmits the retrieved customization information to the MFP 1 (Step S33).

In Step S34, receiving the customization information transmitted from the server 90, the MFP 1 extracts information on the customization screen GC out of the customization information.

In the next Step S35, the MFP 1 judges whether or not there is any “unusable function” which can not be used in the MFP 1 (e.g., 1f) (the apparatus to be used) among the functions corresponding to the buttons in the customization screen GC which is customized for the MFP 1e. This judgment operation is performed on the basis of the information (on the customization screen (operation screen) GC) included in the customization information transmitted from the server 90 and the information (on the functions possessed by the apparatus to be used) which is stored in the storage part 5.

If it is judged that there is no “unusable function” in the customization screen GC, the process goes to Step S38, where the customization screen GC is displayed on the operation panel 63 of the MFP 1.

On the other hand, if it is judged that there is some “unusable function” in the customization screen GC, the process goes to Step S36 from Step S35. In Step S36, the MFP 1 changes the customization screen GC. Specifically, the MFP 1 changes the display mode of the button corresponding to the “unusable function” in the customization screen GC. Further, the mode of the button corresponding to the “unusable function” in the customization screen GC is changed into the “unselectable mode”. Then, the MFP 1 displays the changed customization screen GC on the operation panel 63 of the MFP 1 itself. The operation of changing the customization screen GC will be discussed later.

Then, in Step S37, the MFP 1 displays the changed customization screen GC on its operation panel 63.

After Step S37 or S38, the user performs operation inputs by using the operation screen displayed on the operation panel 63, and a processing in accordance with the operation inputs is performed.

The MFPs 1 each perform the above-discussed operations shown in FIG. 18.

Next, detailed discussion will be made on change of the customization screen GC. As discussed earlier, herein, discussion will be made, assuming that the customization screen GC is generated for the operation panel 63e of the MFP 1e. Further, it is assumed that among the three MFPs 1d, 1e and 1f, the MFP 1d has a largest number of usable functions, the MFP 1e has a second largest number of usable functions and the MFP 1f has a smallest number of usable functions. It is assumed herein that the pixel number size Sd of the operation panel 63d of the MFP 1d, the pixel number size Se of the operation panel 63e of the MFP 1e and the pixel number size Sf of the operation panel 63f of the MFP 1f are equal to one another (Sd=Se=Sf). The pixel number sizes Sd, Se and Sf of the operation panels 63 are, for example, each 640×480 pixels.

In the MFP 1d having a relatively large number of usable functions, for example, if the customization screen GC for the MFP 1e is used, the following operation is performed in the flowchart of FIG. 18.

Specifically, in Step S35, it is judged that all the functions assigned to the buttons in the customization screen GC for the operation panel 63e can be used also in the MFP 1d. Then, in Step S38, the customization screen GC like that in Step S17 is displayed, not being changed, on the operation panel 63d of the MFP 1d.

In another case, if the customization screen GC for the MFP 1e is used in the MFP 1e, similarly, the customization screen GC can be displayed, not being changed, on the operation panel 63e (see FIG. 17).

On the other hand, if the customization screen GC for the MFP 1e is used in the MFP 1f having a relatively small number of usable functions, the following operation is performed in the flowchart of FIG. 18.

Specifically, in Step S35, it is judged that some of the functions assigned to the buttons in the customization screen GC for the operation panel 63e can not be used in the MFP 1f. It is assumed herein that among the functions assigned to the eight buttons BN1 to BN8 in the customization screen GC, four functions “A3”, “Z-Fold”, “Corner Staple” and “2 in 1” assigned to the four buttons BN4, BN5, BN6 and BN8 can not be used.

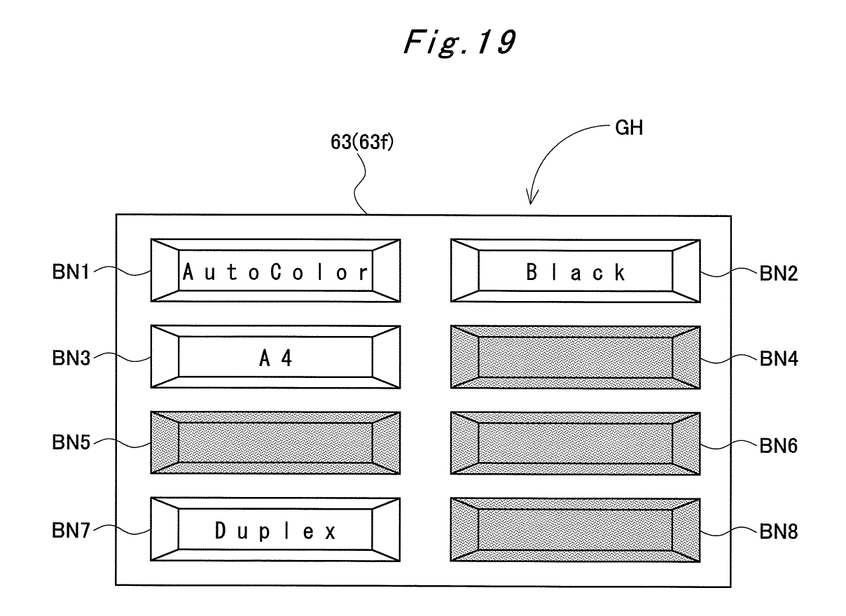

Then, in Step S36, a changed customization screen GC (e.g., a customization screen GH of FIG. 19) is generated, and in Step S37, the changed customization screen GC (GH) is displayed on the operation panel 63f.

As can be seen from comparison between FIGS. 17 and 19, the customization screen GH (FIG. 19) has usable buttons BN1, BN2, BN3 and BN7, like in the customization screen GC. The buttons BN1, BN2, BN3 and BN7 are displayed in the same display mode as shown in FIG. 17 and can be selected (pressed). On the other hand, in the customization screen GH (FIG. 19), the display mode of the buttons BN4, BN5, BN6 and BN8 is changed into a grayout display mode (where these buttons are displayed in paler color (black) than the other buttons). Further, the mode of the buttons BN4, BN5, BN6 and BN8 is changed into an unselectable mode (unpressable mode). Though herein shown is a case where the names of the functions for the buttons BN4, BN5, BN6 and BN8 are not displayed, the display mode of the names is not limited to this case. For example, the names “A3”, “Z-Fold”, “Corner Staple” and “2 in 1” of the functions corresponding to the buttons BN4, BN5, BN6 and BN8 may be displayed in paler color.

With the above operations, if there is some “unusable function” among the functions corresponding to the buttons in the customization screen GC, the customization screen GH after change in which the display mode of the button corresponding to the unusable function is changed is displayed. In more detail, in the customization screen GH after change, the display mode of the button corresponding to the unusable function is changed into one different from the display mode of the other buttons. In other words, if there is a button which can not be used (the button is also referred to as an unusable button) in the customization screen GC, the unusable button is displayed in a manner distinguishable from the other buttons. Therefore, it is possible to display a convenient customization screen (operation screen) on a user basis in consideration of the functions possessed by each MFP 1.

Further, since the mode of the unusable button is changed into an “unselectable mode” in the customization screen GH, it is easy to understand. This can prevent, for example, user's confusion.

In the above case, if there is an unusable button in the customization screen GC, the unusable button is displayed in grayout, but the display mode is not limited to this grayout.

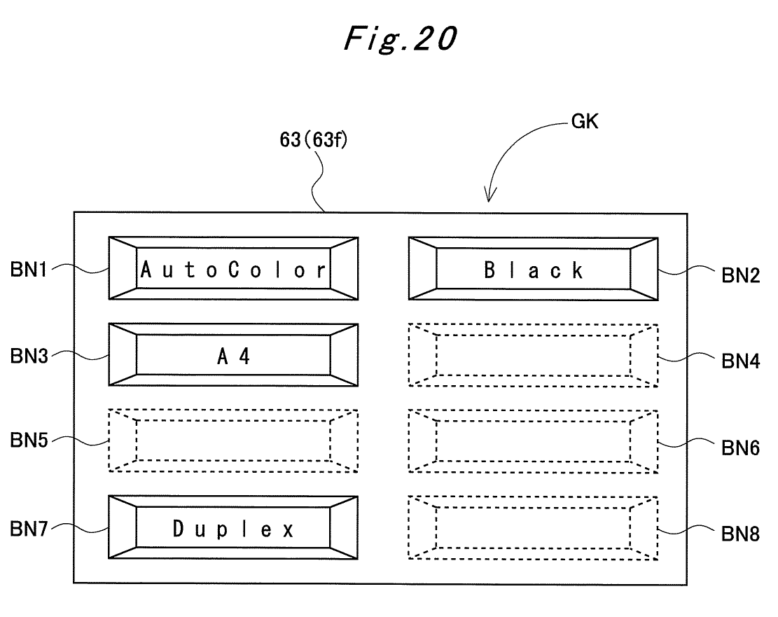

If there is an unusable button in the customization screen GC, for example, such a customization screen GK as shown in FIG. 20 may be displayed on the operation panel 63. In the customization screen GK of FIG. 20, the display mode of the unusable buttons BN4, BN5, BN6 and BN8 is changed into a mode where the outlines of these buttons are indicated by broken lines (the buttons are displayed inconspicuously) and the mode of the unusable buttons is changed into an unselectable mode (unpressable mode). Also in FIG. 20, the names “A3”, “Z-Fold”, “Corner Staple” and “2 in 1” of the functions corresponding to the buttons BN4, BN5, BN6 and BN8 may be displayed in paler color.

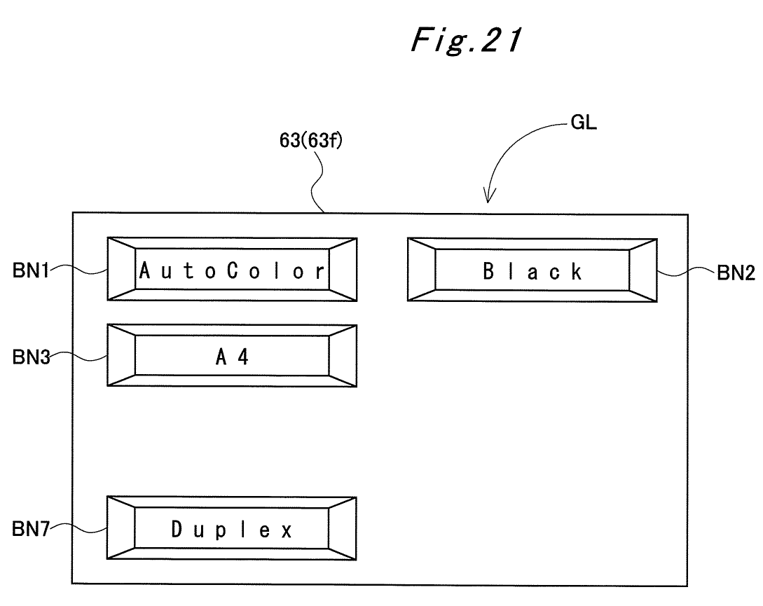

Alternatively, if there is an unusable button in the customization screen GC, such a customization screen GL as shown in FIG. 21 may be displayed on the operation panel 63. In the customization screen GL of FIG. 21, the display mode of the unusable buttons BN4, BN5, BN6 and BN8 is changed into a “non-display mode” where the unusable buttons are not displayed.

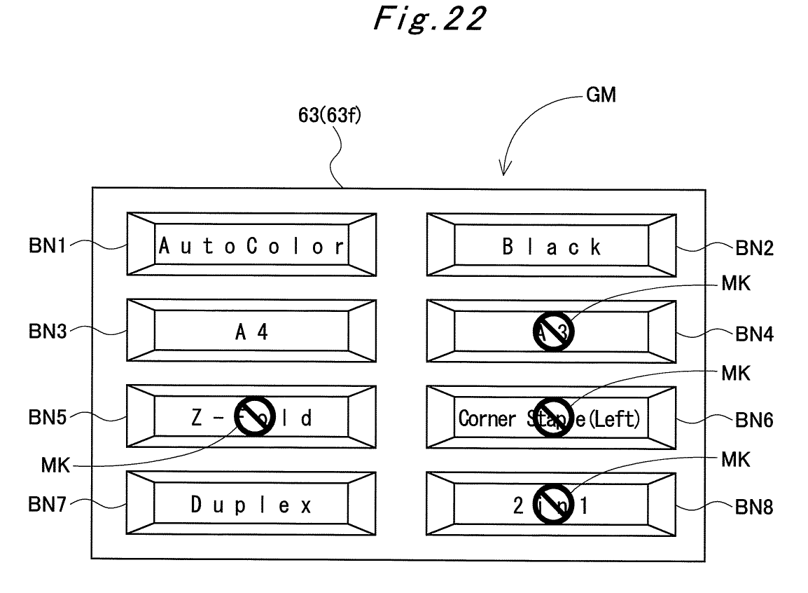

Further alternatively, if there is an unusable button in the customization screen GC, such a customization screen GM as shown in FIG. 22 may be displayed on the operation panel 63. In the customization screen GM of FIG. 22, the display mode of the unusable buttons BN4, BN5, BN6 and BN8 is changed into a mode where a mark MK is superimposed on each of the respective function names of the unusable buttons BN4, BN5, BN6 and BN8 and the mode of the unusable buttons is changed into an unselectable mode (unpressable mode). The mark MK is a mark clearly indicating that the functions corresponding to these buttons can not be used, and also referred to as an “unusable-indication mark”. The mark MK is also referred to as an “unselectable-indication mark” since it indicates that the corresponding buttons can not be selected.

### 4. The Fourth Preferred Embodiment

Next, the fourth preferred embodiment will be discussed. Though discussion has been made in the above third preferred embodiment on the case where the MFP 1 performs the operation of judgment on the customization screen GC and the operation of changing the customization screen, the present invention is not limited to this case. In the fourth preferred embodiment, discussion will be made on a case where the server 90 performs the operation of judgment on the customization screen GC and the operation of changing the customization screen. Hereinafter, discussion will be centered on the characterized feature different from that of the third preferred embodiment.

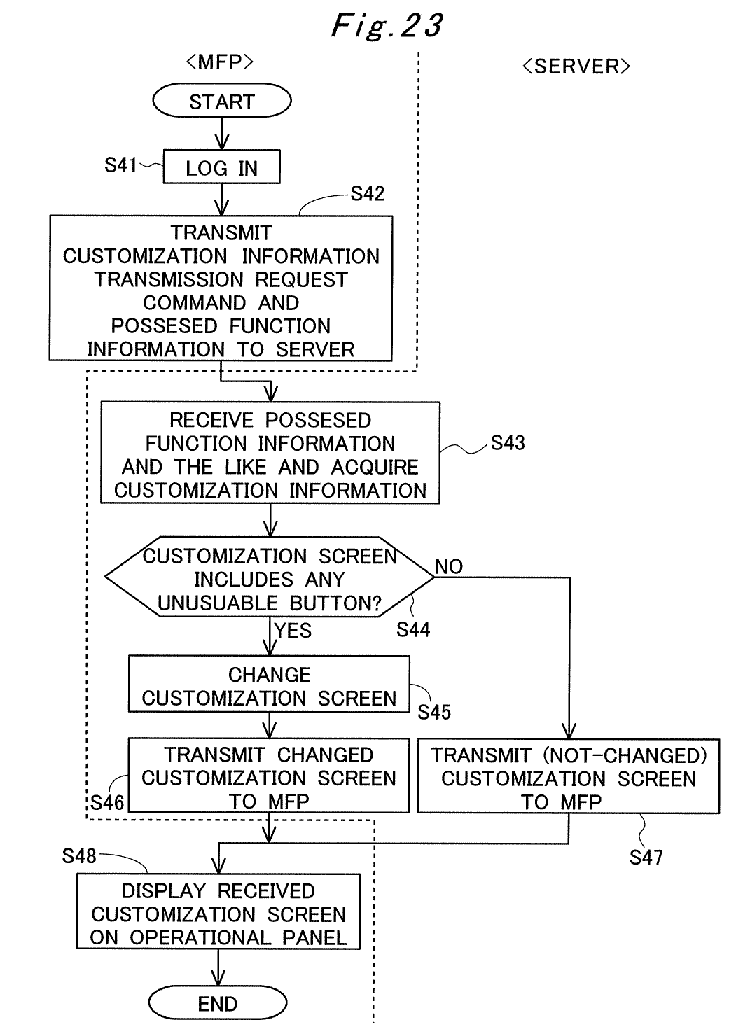

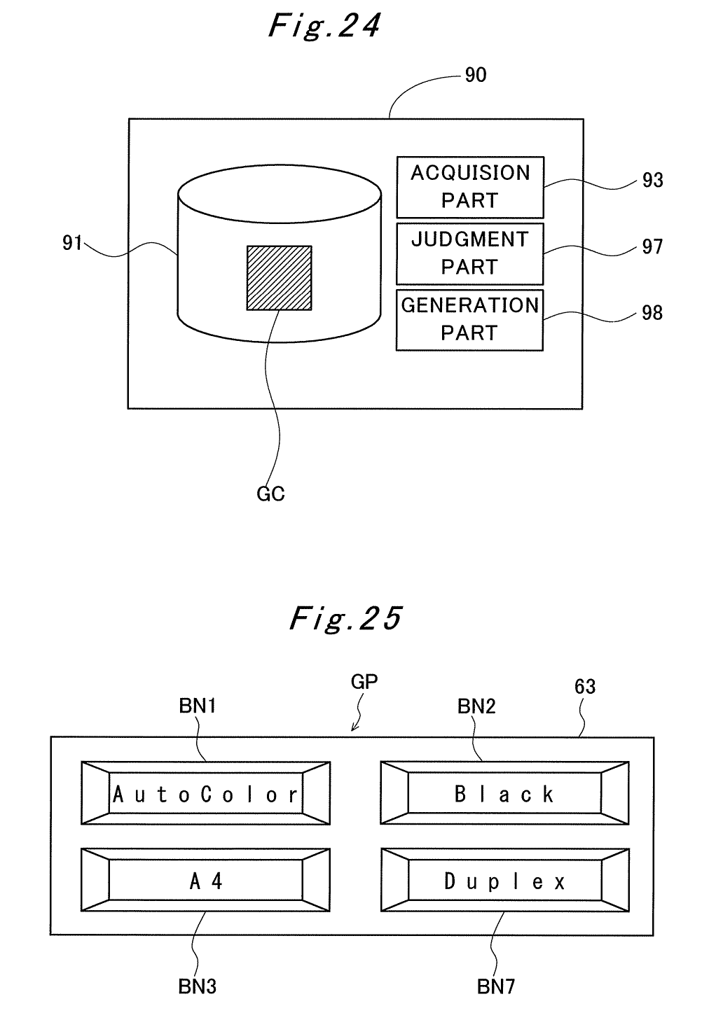

FIG. 23 is a flowchart showing an operation in accordance with the fourth preferred embodiment. FIG. 24 is a view showing various functional parts implemented by execution of a predetermined program in the CPU and the like of the server 90. In the fourth preferred embodiment, instead of the operation shown in FIG. 18, the operation shown in FIG. 23 is performed.

As shown in FIG. 23, first, in Step S41, the user UA logs in the MFP 1. Specifically, the user UA uses the operation input part 61 of the MFP 1 (e.g., 1f) to input a user ID and a password, thus performing a login operation.

In the next Step S42, in response to the login operation by the use UA, the MFP 1 transmits the customization information transmission request command on the user UA to the server 90. The MFP 1 also transmits information on the functions possessed by the MFP 1 (also referred to as “possessed function information”) to the server 90.

In Step S43, the server 90 receives and acquires the possessed function information of the MFP 1. The server 90 also receives the customization information transmission request command from the MFP 1 (e.g., 1f) in Step S43. In response to the request command, the server 90 retrieves the customization information corresponding to the request command out of a plurality of pieces of customization information for a plurality of users which are stored in the storage part 91 of the server 90. Specifically, the server 90 acquires the customization information for the user UA and acquires information of an operation screen (customization screen) GC which is customized for the user UA. This acquisition operation is performed by the acquisition part 93 implemented by execution of software in the CPU and the like of the server 90.

In the Step S44, the server 90 judges whether or not there is any “unusable function” which can not be used in the MFP 1 (e.g., 1f) among the functions corresponding to the buttons displayed in the customization screen GC which is customized for the MFP 1e on the basis of the “possessed function information” and the “information on the customization screen GC”. In other words, the server 90 judges whether there is any “unusable button” or not. This judgment operation is performed by the judgment part 97 implemented by execution of software in the CPU and the like of the server 90.

If it is judged that there is no unusable button in the customization screen GC, the process goes to Step S47, where the information on the customization screen GC is transmitted from the server 90 to the MFP 1. After that, in Step S48, the MFP 1 displays the customization screen GC (not changed).

On the other hand, if it is judged that there is an unusable button in the customization screen GC, the process goes to Step S45. In Step S45, the server 90 changes the customization screen GC and generates a changed customization screen GC (e.g., GH, GK, GL or GM). Then, in Step S46, the server 90 transmits information on the changed customization screen GC (GH or the like) to the MFP 1 (e.g., 1f). This operation of generating such a screen and the like are performed by the generation part 98 implemented by execution of software in the CPU and the like of the server 90.

After that, in Step S48, the MFP 1 displays the changed customization screen GC (GH or the like) which is received on its operation panel 63.

The MFPs 1 each perform the above operations.

With these operations, the same effect as produced in the third preferred embodiment can be produced.

<5. Others>

Though the preferred embodiments of the present invention have been discussed above, the present invention is not limited to the above-discussed cases.

In the first and second preferred embodiments, for example, if it is judged that the customization screen GC can be displayed on the operation panel 63 of the MFP 1, the customization screen GC is displayed, not being changed, on the operation panel 63 of the MFP 1 (in Steps S15 and S18 of FIG. 5), but the present invention is not limited to this case. Specifically, in Step S18, the customization screen GC may be enlarged in accordance with the size of the operation panel 63 on which the screen is displayed and then displayed.

Further, though it is assumed that the MFPs 1a, 1b and 1c have the same functions in the first and second preferred embodiments, the present invention is not limited to this. There is a case, for example, where the MFP 1c can not use some of the functions of the MFP 1b. In this case, if some buttons (referred to as unusable buttons) corresponding to some unusable functions are included in the customization screen GC, the judgment operation in Step S15 may be performed after deleting the unusable buttons from the customization screen GC.

If the MFP 1c can not use the functions corresponding to the buttons BN4, BN5, BN6 and BN8 (see FIG. 4) in the customization screen GC, a new customization screen GC in which these buttons BN4, BN5, BN6 and BN8 are deleted is generated. FIG. 14 is a view showing a new customization screen GC (GF). In FIG. 14, the buttons BN4, BN5, BN6 and BN8 are deleted and the other buttons BN1, BN2, BN3 and BN7 are rearranged in the customization screen GC. Specifically, the four buttons BN1, BN2, BN3 and BN7 are arranged in two columns and two rows.

Then, it is judged whether the new customization screen GF can be displayed or not on the operation panel 63c of the MFP 1c in Step S15 of FIG. 5 (or in Step S24 of FIG. 12) and the like. Specifically, it is judged whether the customization screen GF after rearrangement can be displayed on the operation panel 63c or not on the basis of a result of comparison between the pixel number size Sc of the operation panel 63c of the MFP 1c and required pixel number size (620×230 pixels) which is required to display the customization screen GF after rearrangement.

If it is judged that the customization screen GF after rearrangement can be displayed on the operation panel 63c, the process goes to Step S18, where the customization screen GF after rearrangement is displayed on the operation panel 63c. For example, the customization screen GF after rearrangement shown in FIG. 14 is displayed, not being changed, on the operation panel 63c and used for operation inputs.

On the other hand, if it is judged that the customization screen GF after rearrangement can not be displayed on the operation panel 63c, a new hierarchical menu screen GG (not shown) is generated by grouping a plurality of buttons included in the customization screen GF after rearrangement by function in Step S16. Then, in Step S17, the new hierarchical menu screen GG is displayed on the operation panel 63c. The new hierarchical menu screen GG can be generated in the same manner as the above-discussed hierarchical menu screen GE (however, in accordance with the buttons included in the customization screen GF in this case).

With these operations, by deleting the unusable buttons in the customization screen GC, it is possible to display the relatively simple customization screen GF and perform the operation inputs by using it, instead of using the hierarchical menu screen GE. Further, even in the case where the new hierarchical menu screen GG (not shown) is generated, the menu screen GG can be simplified since unnecessary unusable buttons are deleted.

Further, in the third and fourth preferred embodiments, if it is judged that the customization screen GC can be displayed on the operation panel 63 of the MFP 1, the customization screen GC is displayed, not being changed, on the operation panel 63 of the MFP 1 (in Steps S35 and S38 of FIG. 18), but the present invention is not limited to this case. Specifically, in Step S38, the customization screen GC may be enlarged in accordance with the size of the operation panel 63 on which the screen is displayed and then displayed.

Furthermore, though it is assumed that the respective operation panels 63 of the MFPs 1d, 1e and 1f have the same pixel number size in the third and fourth preferred embodiments, the present invention is not limited to this.

The present invention can be applied to a case, for example, where the operation panel 63f of the MFP 1f (or the operation panel 63d of the MFP 1d) has a pixel number size smaller than that of the operation panel 63e of the MFP 1e. Specifically, if some unusable buttons are included in the customization screen GC, the operation of changing the customization screen GC in Step S45 may be performed after deleting the unusable buttons from the customization screen GC.

It is assumed, for example, that the MFP 1f can not use the functions corresponding to the buttons BN4, BN5, BN6 and BN8 (see FIG. 17) in the customization screen GC. In this case, the MFP if may delete these buttons BN4, BN5, BN6 and BN8 and generate a new customization screen GC (e.g., a customization screen GP (FIG. 25)) in which the other buttons are rearranged in the customization screen GC. FIG. 25 is a view showing a new customization screen (a changed customization screen) GP. In FIG. 25, the unusable buttons BN4, BN5, BN6 and BN8 are deleted and the other four buttons BN1, BN2, BN3 and BN7 are rearranged in the customization screen. Specifically, the four buttons BN1, BN2, BN3 and BN7 are so arranged in two columns and two rows as to be fit in the operation panel 63f of the MFP 1f. With these operations, it is possible to display the relatively simple customization screen GP and perform the operation inputs by using it since the unusable buttons are deleted and the other buttons are rearranged in the customization screen GC.

Further, the present invention can be applied to a case where the operation panel 63d of the MFP 1d (or the operation panel 63f of the MFP 1f) has a pixel number size larger than that of the operation panel 63e of the MFP 1e. In this case, the customization screen GC may be displayed so that predetermined positions (e.g., left upper corners) of the customization screen GC and the operation panel 63d can coincide with each other. Alternatively, the customization screen GC is so displayed as to be centered in the longitudinal direction and/or the transverse direction on the operation panel 63d. Further alternatively, the customization screen GC may be displayed, being enlarged in the longitudinal direction and/or the transverse direction in accordance with the pixel number size of the operation panel 63d.

Furthermore, though the case where the server 90 receives the possessed function information of the MFP 1 from the MFP 1 has been discussed in the fourth preferred embodiment, the present invention is not limited to this. For example, respective pieces of possessed function information on a plurality of MFPs 1 are stored in the server 90, and it may be judged whether there is any “unusable function” or not on the basis of the information and the like stored in the server 90.

While the invention has been shown and described in detail, the foregoing description is in all aspects illustrative and not restrictive. It is therefore understood that numerous modifications and variations can be devised without departing from the scope of the invention.

What is claimed is:

1. A customization system capable of customizing an operation screen displayed on an operation panel of an image forming apparatus on a user basis, comprising:
a storage part for storing customization information for each user;
an acquisition part for acquiring information on a customization screen which is an operation screen customized for a specific user on the basis of customization information for said specific user;
a judgment part for judging whether or not said customization screen can be displayed on a specific operation panel of a specific image forming apparatus out of a plurality of image forming apparatuses on the basis of a result of comparison between the required pixel number size which is required to display said customization screen and the pixel number size of said specific operation panel; and
a display control part for displaying a hierarchical menu screen on said specific operation panel, said hierarchical menu screen being generated by grouping a plurality of buttons included in said customization screen by function, when it is judged that said customization screen can not be displayed on said specific operation panel.

2. The customization system according to claim 1, wherein
said hierarchical menu screen includes
a high-level menu screen including buttons of relatively higher items corresponding to groups which are allocation targets of said plurality of buttons; and
a low-level menu screen to which at least one of said plurality of buttons of relatively lower items is allocated.

3. The customization system according to claim 2, wherein
said display control part displays said high-level menu screen prior to said low-level menu screen.

4. The customization system according to claim 1, wherein
when an unusable button which is a button corresponding to a function which can not be used in said specific image forming apparatus is included in said customization screen, said judgment part generates a new customization screen by rearranging buttons in said customization screen after deleting said unusable button and judges whether said new customization screen can be displayed on said specific operation panel on the basis of a result of comparison between the pixel number size of said specific operation panel and the required pixel number size which is required to display said new customization screen, and
said display control part displays said new customization screen on said specific operation panel when it is judged that said new customization screen can be displayed on said specific operation panel.

5. The customization system according to claim 4, wherein
said display control part displays a hierarchical menu screen which is generated by grouping a plurality of buttons included in said customization screen after said rearrangement by function on said specific operation panel when it is judged that said new customization screen can not be displayed on said specific operation panel.

6. An image forming apparatus capable of customizing an operation screen displayed on its operation panel on a user basis, comprising:
an acquisition part for acquiring information on a customization screen which is an operation screen customized for a specific user on an operation panel of another image forming apparatus other than said image forming apparatus;
a judgment part for judging whether or not said customization screen can be displayed on a specific operation panel of said image forming apparatus on the basis of a result of comparison between the required pixel number size which is required to display said customization screen and the pixel number size of said specific operation panel; and
a display control part for displaying a hierarchical menu screen on said specific operation panel, said hierarchical menu screen being generated by grouping a plurality of buttons included in said customization screen by function, when it is judged that said customization screen can not be displayed on said specific operation panel.

7. A server connected to a plurality of image forming apparatuses via a network, comprising:
a storing part for storing customization information for a specific user on an operation panel of a first image forming apparatus out of a plurality of image forming apparatuses;
an acquiring part for acquiring information on a customization screen which is an operation screen customized for said specific user on the basis of said customization information for said specific user in response to a customization information transmission request command from a second image forming apparatus out of said plurality of image forming apparatuses;
a judging part for judging whether or not said customization screen can be displayed on a specific operation panel provided in said second image forming apparatus on the basis of a result of comparison between the required pixel number size which is required to display said customization screen and the pixel number size of said specific operation panel; and
a generating part for generating a hierarchical menu screen by grouping a plurality of buttons included in said customization screen by function and transmitting information on said hierarchical menu screen to said second image forming apparatus when it is judged that said customization screen can not be displayed on said specific operation panel.

8. A recording medium storing a program to cause a computer to execute the procedures of:
a) acquiring information on a customization screen which is an operation screen on an operation panel of a first image forming apparatus and is customized for a specific user;
b) judging whether or not said customization screen can be displayed on a specific operation panel of a second image forming apparatus on the basis of a result of comparison between the required pixel number size which is required to display said customization screen and the pixel number size of said specific operation panel; and
c) generating a hierarchical menu screen by grouping a plurality of buttons included in said customization screen by function and transmitting said hierarchical menu screen to said second image forming apparatus when it is judged that said customization screen can not be displayed on said specific operation panel.

9. A recording medium storing a program to cause a computer embedded in an image forming apparatus to execute the procedures of:
a) acquiring information on a customization screen which is an operation screen customized for a specific user on an operation panel of another image forming apparatus other than said image forming apparatus;
b) judging whether or not said customization screen can be displayed on a specific operation panel of said image forming apparatus on the basis of a result of comparison between the required pixel number size which is required to display said customization screen and the pixel number size of said specific operation panel; and
c) displaying a hierarchical menu screen generated by grouping a plurality of buttons included in said customization screen by function on said specific operation panel when it is judged that said customization screen can not be displayed on said specific operation panel.

10. A customization system capable of customizing an operation screen displayed on an operation panel of an image forming apparatus on a user basis, comprising:
a storage part for storing customization information for each user;
an acquisition part for acquiring information on a customization screen which is customized for a specific user on the basis of customization information for said specific user;
a judgment part for judging whether or not there is any unusable function which can not be used in a specific image forming apparatus among functions corresponding to buttons in said customization screen; and
a display control part for displaying said customization screen after changing the display mode of a button corresponding to said unusable function on an operation panel of said specific image forming apparatus when it is judged that there is said unusable function.

11. The customization system according to claim 10, wherein
said display control part displays said customization screen after changing the form of displaying the button corresponding to said unusable function on an operation panel of said specific image forming apparatus when it is judged that there is said unusable function.

12. The customization system according to claim 10, wherein
said display control part displays said customization screen with a predetermined mark superimposed on the button corresponding to said unusable function on an operation panel of said specific image forming apparatus when it is judged that there is said unusable function.

13. The customization system according to claim 10, wherein
said display control part displays said customization screen after changing the display mode of the button corresponding to said unusable function into a non-display mode on an operation panel of said specific image forming apparatus when it is judged that there is said unusable function.

14. The customization system according to claim 10, wherein
said display control part displays a customization screen after rearrangement in which the button corresponding to said unusable function is deleted and buttons in said customization screen are rearranged on an operation panel of said specific image forming apparatus when it is judged that there is said unusable function.

15. The customization system according to claim 11, wherein
said display control part displays said customization screen after changing the mode of the button corresponding to said unusable function into an unselectable mode on an operation panel of said specific image forming apparatus when it is judged that there is said unusable function.

16. An image forming apparatus capable of customizing an operation screen displayed on its operation panel on a user basis, comprising:
an acquisition part for acquiring information on a customization screen which is an operation screen customized for a specific user on an operation panel of another image forming apparatus other than said image forming apparatus;
a judgment part for judging whether or not there is any unusable function which can not be used in said image forming apparatus among functions corresponding to buttons in said customization screen; and
a display control part for displaying said customization screen after changing the display mode of a button corresponding to said unusable function on an operation panel of said image forming apparatus when it is judged that there is said unusable function.

17. A server connected to a plurality of image forming apparatuses via a network, comprising:
a storing part for storing customization information for a specific user on an operation panel of a first image forming apparatus out of a plurality of image forming apparatuses;
an acquiring part for acquiring information on a customization screen which is an operation screen customized for said specific user on the basis of said customization information for said specific user in response to a customization information transmission request command from a second image forming apparatus out of said plurality of image forming apparatuses;
a judging part for judging whether or not there is any unusable function which can not be used in said second image forming apparatus among functions corresponding to buttons in said customization screen; and
a transmitting part for transmitting said customization screen after changing the display mode of a button corresponding to said unusable function to said second image forming apparatus when it is judged that there is said unusable function.

18. A recording medium storing a program to cause a computer to execute the procedures of:
a) acquiring information on a customization screen which is a screen on an operation panel of a first image forming apparatus and an operation screen customized for a specific user;
b) judging whether or not there is any unusable function which can not be used in a second image forming apparatus among functions corresponding to buttons in said customization screen; and
c) transmitting said customization screen after changing the display mode of a button corresponding to said unusable function to said second image forming apparatus when it is judged that there is said unusable function.

19. A recording medium storing a program to cause a computer embedded in an image forming apparatus to execute the procedures of:
a) acquiring information on a customization screen which is an operation screen customized for a specific user on an operation panel of another image forming apparatus other than said image forming apparatus;
b) judging whether or not there is any unusable function which can not be used in said image forming apparatus among functions corresponding to buttons in said customization screen; and
c) displaying said customization screen after changing the display mode of a button corresponding to said unusable function on an operation panel of said image forming apparatus when it is judged that there is said unusable function.
